(19) United States
(12) Patent Application Publication
(10) Pub. No.: US 2011/0125852 A1
(43) Pub. Date: May 26, 2011

(54) KEYWORD FILTERED ALERTS FOR GROUP CHATS

(75) Inventor: Larry L. Wolfe, Arvada, CO (US)

(73) Assignee: INTERNATIONAL BUSINESS MACHINES CORPORATION, Armonk, NY (US)

(21) Appl. No.: 12/625,906

(22) Filed: Nov. 25, 2009

(51) Int. Cl. G06F 15/16; G06F 3/00

(52) U.S. Cl. 709/206; 715/758

(57) ABSTRACT

A method and apparatus for processing messages. In one illustrative embodiment, a processor unit determines whether a predetermined number of keywords or a predetermined number of combinations of keywords associated with a recipient of a message is present in the message in response to receiving the message. In response to a determination that the number of keywords is present in the message, the processor unit generates an alert for the recipient.

### BACKGROUND

1. Field:

The invention relates generally to managing chat sessions in a distributed computer system.

2. Description of the Related Art

Instant messaging is an online chat medium, which allows users to communicate with each other and collaborate in real-time over a network data processing system. With instant messaging, messages are sent as quickly as possible from one client program to another client program. The typical delays in checking for messages and cuing of messages at an email server are not present with instant messaging systems. Instant messaging is commonly used over the Internet. Instant messaging applications may monitor and report the status of users that have established each other as online contacts. This information is typically presented to a user in a window. Instant messaging applications are also often used by users conducting business. By utilizing instant messaging, business users can view each other's availability and initiate a text conversation with colleagues or customers when a desired contact becomes available.

Typically, with instant messaging applications, communications between users are initiated by users selecting the name of the person with which they desire to communicate. Then, the users type messages in a dialog box in the window and press “send”. These messages may appear instantly on the selected recipient's computer.

The exchange of these types of messages between two users is referred to as a chat session. Further, a chat session may involve more than two users. These types of chat sessions are referred to as group chat sessions.

The number of participants in a group chat session may be large, and multiple threads may occur on various topics. Some of these topics may not involve or need some of the participants.

For example, a group chat session may be used to discuss the deployment of an online store for a client. This group chat session may involve a discussion of many components, including software and hardware. For example, a discussion of a creation of a database may occur. The discussion of the database may be relevant to programmers or database experts who are involved with the database to be created. This discussion may not be useful or relevant to participants who are involved in deploying the hardware for the online store.

Currently, a participant to a group chat session may be alerted every time a message is sent during the group chat session. The user reviews each message to determine whether the user needs to provide input or take actions. Although this type of communication is useful to allow many participants to talk to each other in different locations, this type of communication using group chat sessions may be time consuming and tedious when the number of participants are large and many topics are discussed.

Therefore, it would be advantageous to have a method and apparatus that takes into account at least some of these issues, as well as possibly other issues.

### SUMMARY

The illustrative embodiments provide a method and apparatus for processing messages in a chat session. In one illustrative embodiment, a processor unit determines whether a predetermined number of keywords or a predetermined number of combinations of keywords associated with a recipient of a message is present in the message in response to receiving the message in the chat session. In response to a determination that the predetermined number of keywords or the predetermined number of combinations of keywords is present in the message, the processor unit generates an alert for the recipient.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a diagram of a data processing system in accordance with an illustrative embodiment

FIG. 3 is a diagram of a messaging environment in accordance with an illustrative embodiment;

FIG. 4 is an illustration of a graphical user interface displayed on a client computer in accordance with an illustrative embodiment;

FIG. 5 is a flowchart of a filtering process in a messaging program running on a client computer or server program running on a server computer for defining keywords in accordance with an illustrative embodiment;

FIG. 6 is a flowchart of a filtering process in a messaging program running on a client computer for processing messages in accordance with an illustrative embodiment;

FIG. 7 is a flowchart of a filtering process for a server program running on a server computer for processing messages in accordance with an illustrative embodiment; and

FIG. 8 is a flowchart of a filtering process for a messaging program running on a client computer for processing messages for alerts in accordance with an illustrative embodiment.

### DETAILED DESCRIPTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer-readable storage medium(s) may be utilized. Examples (a non-exhaustive list) of the computer-readable storage medium would include the following: a portable computer diskette, a hard disk, a random access memory (RAM), a read-only memory (ROM), an erasable programmable read-only memory (EPROM or Flash memory), a portable compact disk read-only memory (CDROM), an optical storage device, or a magnetic storage device. In addition to using a computer program product, computer program code also may be downloaded to a computer via a network.

Computer program code for carrying out operations of the present invention is written in any combination of one or more programming languages, including an object-oriented programming language, such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer is connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams and combinations of blocks in the flowchart illustrations and/or block diagrams can be implemented by computer program instructions.

These computer program instructions are provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

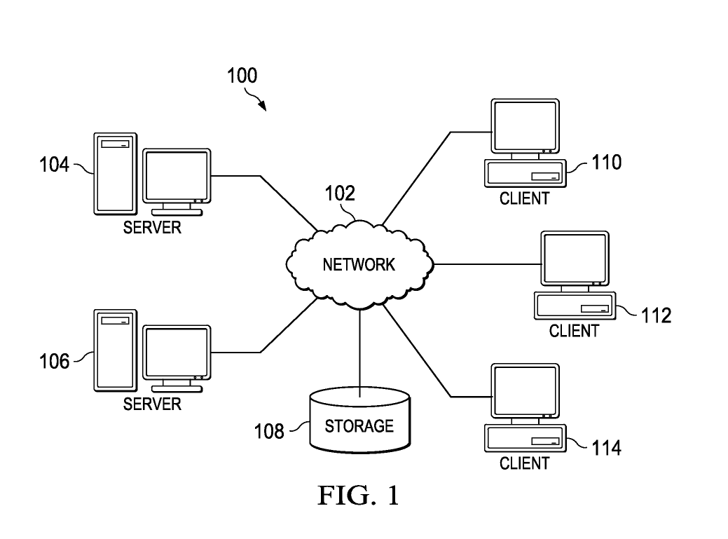

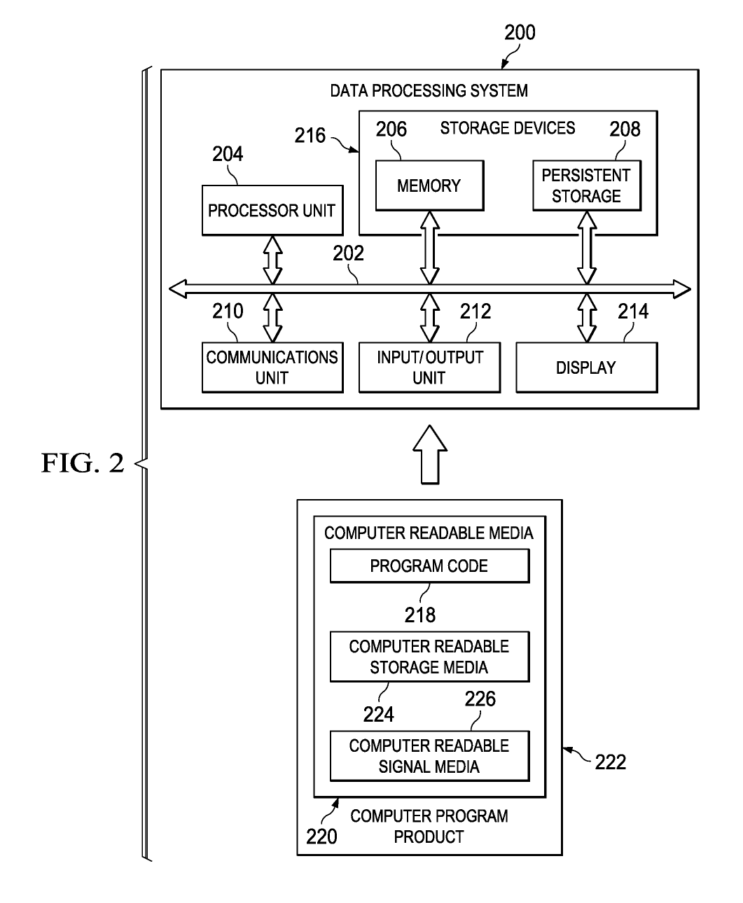

With reference now to the figures and, in particular, with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments are implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 are, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and/or other devices not shown.

Program code located in network data processing system 100 is stored on a computer recordable storage medium and downloaded to a data processing system or other device for use. For example, program code is stored on a computer recordable storage medium on server computer 104 and downloaded to client computer 112 over network 102 for use on client computer 112.

For example, client computers 110, 112, and 114 may run program code for a messaging program. The messaging program allows for messages to be exchanged between users at client computers 110, 112, and 114. In these examples, the messaging takes the form of instant messages for chat sessions that are held between users at client computers 110, 112, and 114. One or more illustrative embodiments may be implemented at client computers 110, 112, and 114 and/or at server computers 104 and 106 to facilitate the exchange of messages. Further, different illustrative embodiments may be implemented in one or more of these components to generate alerts to identify messages that may be relevant to particular participants in the chat session.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

Turning now to FIG. 2, a diagram of a data processing system is depicted in accordance with an illustrative embodiment. In this depicted example, data processing system 200 is an example of one implementation for server computer 104, server computer 106, client computer 110, client computer 112, and/or client computer 114 in FIG. 1. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for running by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 for running by processor unit 204. Program code 218 and computer readable media 220 form computer program product 222. In one example, computer readable media 220 may be computer readable storage media 224. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200.

Alternatively, program code 218 may be transferred to data processing system 200 via a network. These signals may be transmitted over communications links, such as wireless communications links, an optical fiber cable, a coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system via a network for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

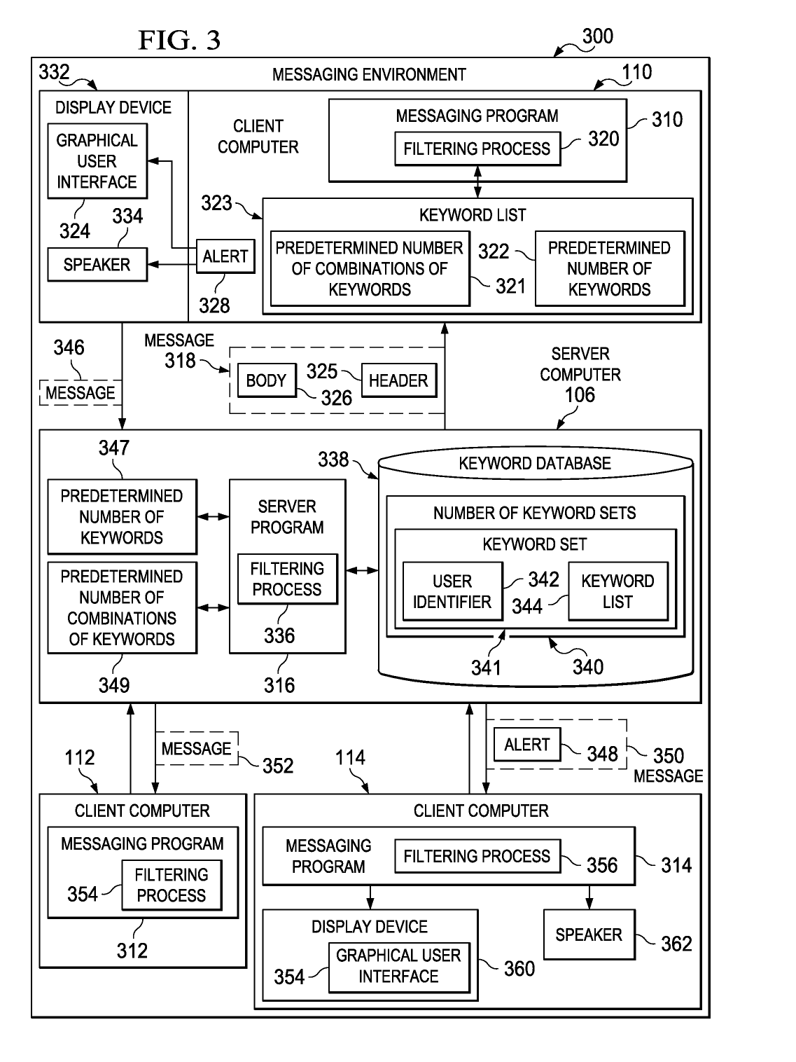

With reference now to FIG. 3, a diagram of a messaging environment is depicted in accordance with an illustrative embodiment. In this illustrative example, messaging environment 300 may be implemented using network data processing system 100 in FIG. 1. Messaging environment 300 includes server computer 106 and client computers 110, 112, and 114 from FIG. 1 in these illustrative examples. As depicted, data processing system 200 in FIG. 2 is to implement server computer 106 and client computers 110, 112, and 114.

Client computers 110, 112, and 114 exchange messages with server computer 106. The exchange of messages is performed by messaging programs 310, 312, and 314. Messaging program 310 runs on client computer 110, messaging program 312 runs on client computer 112, and messaging program 314 runs on client computer 114. In addition, server computer 106 also runs server program 316.

Server program 316, in these illustrative examples, provides messaging services to messaging programs 310, 312, and 314. In these illustrative examples, the messaging services are for instant messaging. Server program 316 may provide contact information to messaging programs 310, 312, and 314 to establish a group chat session between the users of these programs.

Additionally, server program 316 also may relay messages between messaging programs 310, 312, and 314. In some illustrative examples, server program 316 may only aid in establishing contact between the different messaging programs. With this type of embodiment, the messaging programs send messages to each other without the involvement of server program 316.

In this illustrative example, messaging program 310 receives message 318. Message 318 is processed using filtering process 320 in these illustrative examples. As depicted, filtering process 320 is a process in messaging program 310. Of course, in other illustrative examples, filtering process 320 may run as a plug in, a separate program, or some other suitable form of program code running on client computer 110.

Filtering process 320 determines whether predetermined number of keywords 322 or predetermined number of combinations of keywords 321 from keyword list 323 is present in message 318. A number, as used herein, refers to one or more items. For example, a number of keywords is one or more keywords. In addition, the user may select or change keywords within keyword list 323 using graphical user interface 324 in these illustrative examples.

Predetermined number of keywords 322 is a number of keywords that has been previously selected or set prior to the messages being exchanged. Predetermined number of keywords 322 may be selected in a number of different ways. For example, predetermined number of keywords 322 may be selected by a user input, a program using a number of rules, and/or some other suitable source. Predetermined number of combinations of keywords 321 is a number of combinations of keywords selected or set prior to the messages being exchanged. For example, predetermined number of combinations of keywords 321 may be selected through a user input, a program using a number of rules, and/or some other suitable source.

In these illustrative examples, a combination of keywords is any combination of two or more keywords. For example, filtering process 320 determines whether both “database” and “database manager” are present in the message. Filtering process 320 also may look for a number of combinations. For example, filtering process 320 may determine whether a first combination of keywords including “database” and “database manager” and a second combination of keywords including “router”, “interface”, and “network” is present in message 318. When looking for a combination of keywords, filtering process 320 only identifies a match if each keyword in the combination of keywords is found in message 318. The combination of keywords may be in any order in some illustrative examples. In other illustrative examples, the keywords may be required to be in a selected order within message 318.

Filtering process 320 may look for predetermined number of keywords 322 or predetermined number of combinations of keywords 321 within header 325 and/or body 326 of message 318. In these illustrative examples, a keyword within predetermined number of keywords 322 or predetermined number of combinations of keywords 321 may be text, symbols, numbers, a phrase, a group of words in a specific order, and/or other suitable information.

If predetermined number of keywords 322 or predetermined number of combinations of keywords 321 from keyword list 323 is found in message 318, filtering process 320 generates alert 328. Alert 328 may take a number of different forms. For example, without limitation, alert 328 may be a graphical indicator, a sound, an email message, a text message for a mobile phone, a popup window, or any combination of these or other suitable types of alerts. Alert 328 may include information, such as the type of alert to present, keywords identified in the message, and/or other suitable information.

In this illustrative example, alert 328 is presented through graphical user interface 324 on display device 332 or through speaker 334 for client computer 110. If the alert takes the form of an email message or a text message to a phone, filtering process 320 may generate and send the message in addition to or in place of using display device 332 and speaker 334.

In some illustrative examples, filtering process 336 is implemented in server computer 106. In these illustrative examples, filtering process 336 is implemented in server program 316. Of course, in other illustrative embodiments, filtering process 336 may be implemented as a separate program or process from server program 316.

Filtering process 336 processes each message handled by server program 316 using keyword database 338. In this illustrative example, keyword database 338 is a collection of information. In this illustrative example, keyword database 338 comprises number of keyword sets 340.

A keyword set in number of keyword sets 340, such as keyword set 341, comprises user identifier 342 and keyword list 344. Keyword list 344 is a data structure containing keywords. Keyword list 344 identifies keywords for which alerts should be generated for a particular user as identified by user identifier 342. User identifier 342 is a user for which keyword list 344 applies. For example, each user or some subset of users may have a keyword set. The keyword set for a particular user is identified using user identifier 342. Keyword list 344 is the keywords associated with that particular user. In these illustrative examples, the keyword list in a keyword set within number of keyword sets 340 in keyword database 338 may be different for each user. Different users may have different keywords within their keyword lists.

The user, in these illustrative examples, is the user of a messaging program, such as, for example, without limitation, messaging program 310. In these depicted examples, user identifier 342 is a user identifier for a user in the chat session. Each user is associated with a keyword set within number of keyword sets 340, such as keyword set 341. In this manner, each user may have a unique set of keywords. The association is made using user identifier 342.

Keyword list 344 in keyword set 341 within keyword database 338 on server computer 106 is defined at server computer 106 or remotely by one or more users. When defined remotely, a user may use a graphical interface, such as graphical user interface 324 for messaging program 310 running on client computer 110 to define keywords for keyword list 344. Further, in some illustrative embodiments, one user may set keywords in keyword lists within number of keyword sets 340 in keyword database 338 for other users.

In these illustrative examples, filtering process 336 also may generate alerts. For example, when message 346 is received from messaging program 310, message 346 is processed by filtering process 336 to determine whether the content in message 346 contains predetermined number of keywords 347 or predetermined number of combinations of keywords 349 in any of number of keyword sets 340. If predetermined number of keywords 347 or predetermined number of combinations of keywords 349 associated with a user is identified in message 346, alert 348 is generated and placed into a copy of message 346 for the user.

For example, message 350 and message 352 are copies of message 346. If predetermined number of keywords 347 or predetermined number of combinations of keywords 349 for the user of messaging program 312 or messaging program 314 is present in message 346, alert 348 is generated. Predetermined number of keywords 347 and/or predetermined number of combinations of keywords 349 may not be present for all users if the users have different keywords in their keyword lists. This determination is made in the depicted examples by comparing message 346 to the keywords in the keyword list for the user of messaging program 312.

In this example, predetermined number of keywords 347 or predetermined number of combinations of keywords 349 is present for the user of messaging program 314 and not for the user of messaging program 312. As a result, alert 348 is placed into message 350. In this illustrative example, predetermined number of keywords 347 and predetermined number of combinations of keywords 349 is not present for the user of messaging program 312, because the keyword list associated with the user of messaging program 312 does not contain any keywords that can be found in message 346. As a result, alert 348 is not placed into message 352. Message 350 is sent to messaging program 314, and message 352 is then sent to messaging program 312.

In these illustrative examples, messaging program 312 includes filtering process 354, and messaging program 314 includes filtering process 356. These filtering processes are configured to display alerts received in messages.

For example, when messaging program 314 receives message 350, filtering process 356 identifies alert 348 as being present in message 350. In response to identifying alert 348 in message 350, filtering process 356 presents alert 348 in graphical user interface 358 on display device 360. Alert 348 also may be presented as a sound on speaker 362.

In this manner, one or more different illustrative embodiments in messaging environment 300 may be used to generate alerts for users of messaging programs. These alerts allow users to know when they may need to pay increased attention to messages. In these examples, the alerts are generated through the use of keyword lists, such as keyword list 323 and keyword list 344.

With respect to the use of keyword lists in keyword database 338 on server computer 106, these keyword lists are managed in a number of different ways. For example, without limitation, the different keyword lists in a keyword database may be cleared or removed after a chat session ends. In other illustrative embodiments, the keyword lists may be maintained for longer periods of time. For example, the keyword lists may be maintained for related sessions that may occur at later points in time. These keyword lists may be maintained through using additional identifiers within keyword set 341 to allow a user to select a particular keyword list. In other words, a user may have more than one keyword list in a keyword database, depending on the implementation. In a similar manner, keyword list 323 on client computer 110 also may be managed in the same way.

The illustration of messaging environment 300 in FIG. 3 is not meant to imply physical or architectural limitations to the manner in which different advantageous embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, other numbers of messaging programs and computers may be present in addition to the ones illustrated in these examples. As another example, messaging programs 310, 312, and 314 may be the same type of messaging programs or different types. For example, without limitation, these messaging programs may be implemented using IBM Lotus Same Time, Skype, Softros LAN Messenger, and/or other suitable types of messaging programs. IBM Lotus Same Time is available from International Business Machines Corporation. Skype is available from Skype, Limited. Softros LAN Messenger is available from Softros Systems, Inc.

As another example, filtering process 354 and filtering process 356 also may filter messages in a similar fashion to filtering process 320. Also, filtering process 320 also may be configured to identify alerts located in messages.

Also, in some illustrative embodiments, not all messaging programs may include a filtering process. If an alert is received in a message in which a filtering process is not present, the alert may be ignored by the messaging program in these illustrative examples.

As yet another illustrative example, messaging programs 310, 312, and 314 may take the form of web browsers. With this type of implementation, server program 316 may provide all the processing to identify keywords and generate alerts, such as alert 348. In still other illustrative examples, messaging programs 310, 312, and 314 may take the form of web browsers with filtering processes 320, 354, and 356, respectively, being implemented as plug ins, outputs, scripts, or other suitable forms of program code.

In still other illustrative embodiments, the alerts may not be placed within the messages. Instead, the alerts may be sent separately but associated with the message. For example, an identifier may be used to associate an alert with a message.

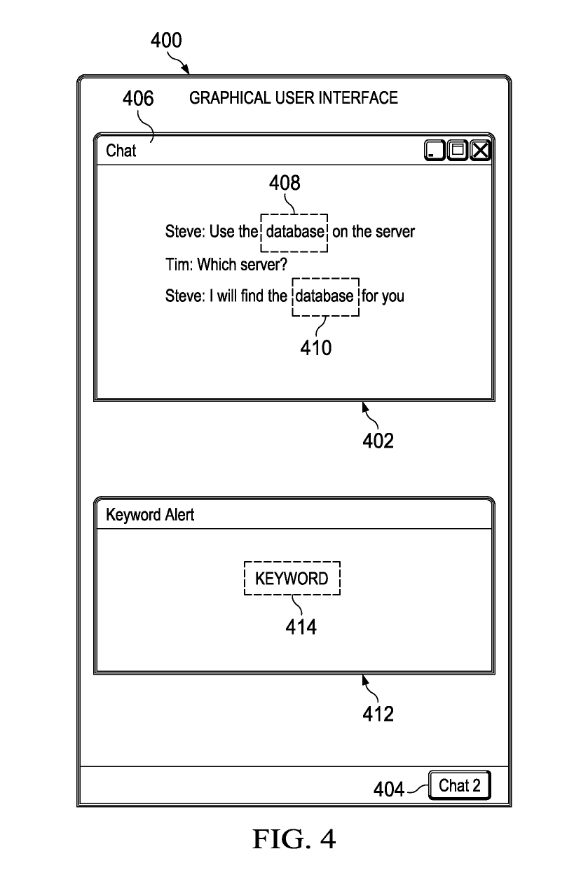

With reference now to FIG. 4, an illustration of a graphical user interface displayed on a client computer is depicted in accordance with an illustrative embodiment. In this illustrative example, graphical user interface 400 is an example of graphical user interface 324 in FIG. 3 displayed on client computer 110 in FIG. 1. Graphical interface 400 is displayed on display device 332 for client computer 110 in FIG. 3 in this illustrative example.

In graphical user interface 400, two messaging programs may be present. Window 402 illustrates one messaging program in a maximized state, while icon 404 illustrates the presence of another messaging program in a minimized state. In these illustrative examples, alerts may be presented in a number of different ways within graphical user interface 400.

For example, without limitation, bar 406 may change colors and/or flash to indicate that a keyword within the number of keywords for the user is present in a message. Further, the keywords also may be graphically identified. In one illustrative example, text 408 and text 410 may be highlighted, flashing, or presented in other manners. As another illustrative example, text 408 and text 410 may be presented using bolding, italics, a different font size, a different font type, or some other suitable indicator to differentiate or direct attention to text 408 and text 410 from other words within window 402. In still other illustrative examples, icon 404 may be flashing.

In another example, popup window 412 may be presented. Popup window 412 may indicate that a keyword has been identified. Further, text 414 may be presented to indicate the keywords present in the message. Further, the alerts also may be presented using sound over a speaker in addition to or in place of these graphical indicators.

The illustration of the graphical indicators in graphical user interface 400 are only presented for purposes of illustrating some examples of graphical indicators and are not intended to be exhaustive. For example, although multiple types of graphical indicators are presented in graphical user interface 400, some illustrative embodiments may only include a single type of graphical indicator. Further, other types of graphical indicators in addition to or in place of the ones depicted may be used in other combinations, depending on the particular implementation. In addition, alerts may be presented using sound in addition to or in place of graphic alerts depicted for graphical user interface 400 in FIG. 4.

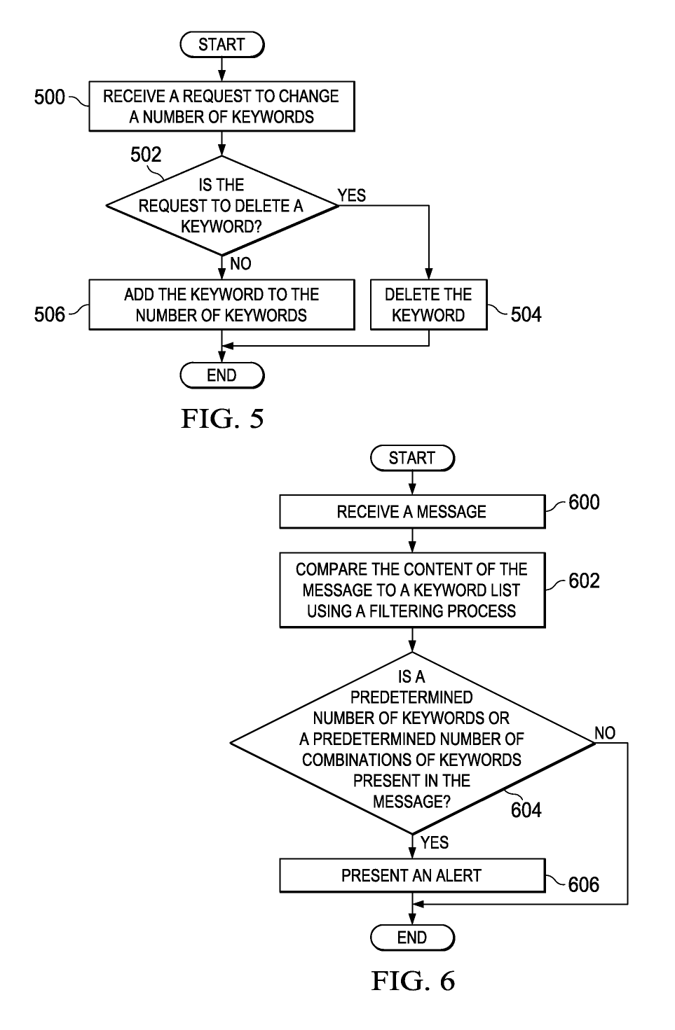

With reference now to FIG. 5, a flowchart of a filtering process in a messaging program running on a client computer or server program running on a server computer for defining keywords is depicted in accordance with an illustrative embodiment. The process illustrated in FIG. 5 may be implemented in messaging environment 300 in FIG. 3. For example, the process illustrated in FIG. 5 may be implemented in filtering process 320 in messaging program 310 running on client computer 110 or filtering process 336 in server program 316 running on server computer 106 in FIG. 3 in these illustrative examples. In messaging program 310, filtering process 320 or filtering process 336 is used to select or change keywords for the user of messaging program 310. When the process is implemented in filtering process 336 for server program 316, the different steps may be used to set keywords for multiple users.

Filtering process 320 or filtering process 336 begins by receiving a request to change a number of keywords (step 500). Filtering process 320 or filtering process 336 makes a determination as to whether the request is to delete a keyword (step 502). If the request is to delete a keyword, filtering process 320 or filtering process 336 deletes the keyword (step 504), with the process terminating thereafter.

With reference again to step 502, if the request is not to delete a keyword, filtering process 320 or filtering process 336 adds the keyword to the number of keywords (step 506), with the process terminating thereafter.

With reference now to FIG. 6, a flowchart of a filtering process in a messaging program running on a client computer for processing messages is depicted in accordance with an illustrative embodiment. The process illustrated in FIG. 6 may be implemented as program code for filtering process 320 in messaging program 310 running on client computer 110 in FIG. 3.

Filtering process 320 begins by receiving a message (step 600). Filtering process 320 compares the content of the message to keyword list 323 (step 602). Keyword list 323 contains one or more keywords in these examples.

Filtering process 320 makes a determination as to whether a predetermined number of keywords or a predetermined number of combinations of keywords in keyword list 323 are present in the message (step 604). In step 604, filtering process 320 determines whether the predetermined number of keywords or the predetermined number of combinations of keywords within keyword list 323 is present in the message. This determination is positive if any keyword or combination of keywords within keyword list 323 is present in the message.

If a match is present, filtering process 320 presents alert 328 (step 606). In step 606, the alert takes the form of a graphical indicator. This graphical indicator may be presented in a manner such as that illustrated in graphical user interface 400 in FIG. 4. Additionally, alert 328 may be presented as a sound on speaker 334 in addition to or in place of the graphical indicator. The process then terminates thereafter. With reference again to step 604, if a match is not present, the process terminates.

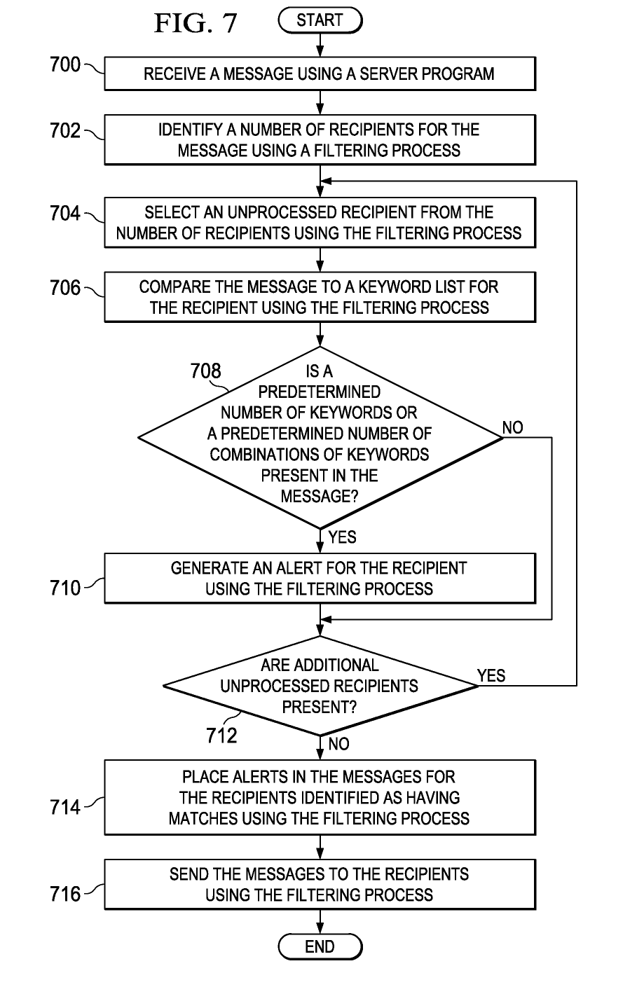

With reference now to FIG. 7, a flowchart of a filtering process for a server program running on a server computer for processing messages is depicted in accordance with an illustrative embodiment. The process illustrated in FIG. 7 may be implemented as program code for filtering process 336 for server program 316 running on server computer 106.

Filtering process 336 receives a message (step 700). Filtering process 336 identifies a number of recipients for the message (step 702). The number of recipients, in these examples, may be every participant in the chat session. Next, filtering process 336 selects an unprocessed recipient from the number of recipients (operation 704). Filtering process 336 then compares the message to a keyword list for the recipient (step 706). In step 706, the keyword list contains one or more keywords or one or more combinations of keywords. These keywords are compared to the message to determine whether a number of the keywords are present.

Filtering process 336 makes a determination as to whether a predetermined number of keywords or a predetermined number of combinations of keywords are present in the message (step 708). In other words, the predetermined number of keywords and the predetermined number of combinations of keywords may be one or more keywords or one or more combinations of keywords, respectively, within the keyword list.

If a match is present, filtering process 336 generates alert 348 for the recipient (step 710). Filtering process 336 then makes a determination as to whether additional unprocessed recipients are present (step 712). If additional unprocessed recipients are present, filtering process 336 returns to step 704 to select another recipient for processing.

Otherwise, filtering process 336 places alerts in the messages for the recipients identified as having matches (step 714). Filtering process 336 then sends the messages to the recipients (step 716), with the process terminating thereafter. With reference again to step 708, if the match between the number of keywords and the message is not present, filtering process 336 proceeds to step 712 as described above.

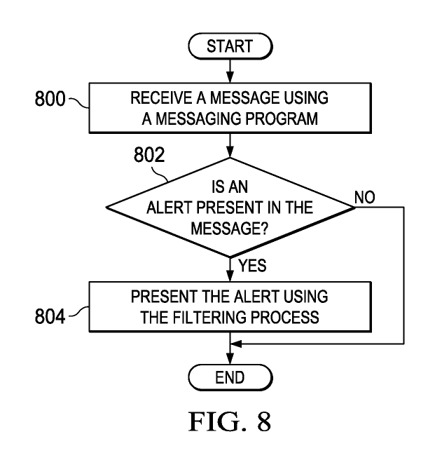

Next, in FIG. 8, a flowchart of a filtering process for a messaging program running on a client computer for processing messages for alerts is depicted in accordance with an illustrative embodiment. The process illustrated in FIG. 8 may be implemented as program code for filtering process 356 in messaging program 314 running on client computer 114 in FIG. 3.

Filtering process 356 receives a message (step 800). Filtering process 356 in messaging program 314 determines whether an alert is present in the message (step 802). If an alert is present, filtering process 356 presents the alert (step 804), with the process terminating thereafter. With reference again to step 802, if an alert is not present, the process terminates. In other words, the message is presented without an alert.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

For example, in some illustrative embodiments, the alerts may be sent directly to the recipients, rather than placing the alerts in the messages for the recipients in which keywords for those recipients match content in the message. In yet other illustrative embodiments, the messages may be sent sequentially as they are processed, rather than sending the messages as a group, as illustrated in FIG. 7.

Thus, the different illustrative embodiments provide a method and apparatus for processing messages. In response to receiving a message, a processing unit determines whether a number of keywords associated with the recipient is present in the message. In response to a determination that the number of keywords is present in the message, an alert is generated for the recipient.

In this manner, participants in a chat session may more easily identify messages to which they need to read or process. When large numbers of participants are present, a participant can more easily identify messages of interest or relevance to that participant with the filtering process illustrated above.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment, or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any system. For the purposes of this description, a computer-readable STORAGE medium can be any tangible apparatus that can contain, store, the program for use by or in connection with the running of instructions on a system, apparatus, or device.

The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual running of the program code, bulk storage, and cache memories which provide temporary storage of at least some program code in order to reduce the number of times code must be retrieved from bulk storage during running.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening networks. Modems, cable modems, and Ethernet cards are just a few of the currently available types of network adapters.

The description of the present invention has been presented for purposes of illustration and description, and it is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated. The embodiments have been shown and described only as examples of implementations and are not meant to determine the scope of the invention, and the claims in the following section determine the scope of the invention.

What is claimed is:

1. A method for processing messages in a chat session, the method comprising the steps of:
responsive to receiving a message in the chat session, determining, by a processor unit, whether the message contains a predetermined number of keywords or a predetermined number of combinations of keywords associated with a recipient of the message;
responsive to a determination that the predetermined number of keywords or the predetermined number of combinations of keywords associated with the recipient is present in the message, generating, by the processor unit, an alert for the recipient.

2. The method of claim 1 further comprising:
receiving, by the processor unit, a user input defining a keyword;
responsive to receiving the user input, adding, by the processor unit, the keyword to the predetermined number of keywords or the predetermined number of combinations of keywords.

3. The method of claim 1, wherein the step of generating, by the processor unit, the alert for the recipient comprises:
displaying, by the processor unit, a graphical indicator on a graphical user interface.

4. The method of claim 1, wherein the step of generating, by the processor unit, the alert for the recipient comprises:
generating a sound on a speaker.

5. The method of claim 1, wherein the step of generating, by the processor unit, the alert for the recipient comprises:
placing an indicator for the alert in the message.

6. The method of claim 5 further comprising:
sending the message to the recipient after placing the indicator for the alert in the message.

7. The method of claim 1, wherein the message is a message in the chat session generated using an instant messaging program.

8. The method of claim 1, wherein the chat session is between a group of participants.

9. The method of claim 1, wherein the alert is selected from one of a flashing icon, a graphical indicator, a color, a sound, a text message on a mobile phone, an email message, and a pop-up window.

10. A computer comprising:
a bus;
a storage device connected to the bus;
a processor unit connected to the bus; and
program code stored on the storage device, wherein the processor unit runs the program code to determine whether a predetermined number of keywords or a predetermined number of combinations of keywords associated with a recipient of a message in a chat session is present in the message in response to receiving the message in the chat session and generates an alert for the recipient in response to a determination that the predetermined number of keywords or the predetermined number of combinations of keywords is present in the message.

11. The computer of claim 10, wherein the processor unit further runs the program code to receive a user input defining a keyword and add the keyword to the predetermined number of keywords or the predetermined number of combinations of keywords in response to receiving the user input.

12. The computer of claim 10, wherein in generating the alert for the recipient, the processor unit runs the program code to display a graphical indicator on a graphical user interface.

13. The computer of claim 10, wherein in generating the alert for the recipient, the processor unit runs the program code to generate a sound on a speaker.

14. The computer of claim 10, wherein in generating the alert for the recipient, the processor unit runs the program code to place an indicator for the alert in the message.

15. A computer program product comprising:
a computer readable storage medium;
first program code, stored on the computer readable storage medium, responsive to receiving a message in a chat session, for determining whether a predetermined number of keywords or a predetermined number of combinations of keywords associated with a recipient of the message is present in the message; and
second program code, stored on the computer readable storage medium, responsive to a determination that the predetermined number of keywords or the predetermined number of combinations of keywords is present in the message, for generating an alert for the recipient.

16. The computer program product of claim 15 further comprising:
third program code, stored on the computer readable storage medium, for receiving a user input defining a keyword; and
fourth program code, stored on the computer readable storage medium, responsive to receiving the user input, for adding the keyword to the predetermined number of keywords or the predetermined number of combinations of keywords.

17. The computer program product of claim 15, wherein the second program code comprises:
program code, stored on the computer readable storage medium, for displaying a graphical indicator on a graphical user interface.

18. The computer program product of claim 15, wherein the second program code comprises:
program code, stored on the computer readable storage medium, for generating a sound on a speaker.

19. The computer program product of claim 15, wherein the second program code comprises:
program code, stored on the computer readable storage medium, for placing an indicator for the alert in the message.

20. The computer program product of claim 19 further comprising:
program code, stored on the computer readable storage medium, for sending the message to the recipient after placing the indicator for the alert in the message.
